(19) United States
(12) Patent Application Publication
(10) Pub. No.: US 2026/0073578 A1
(43) Pub. Date: Mar. 12, 2026

(54) SINGLE PASS VIDEO GENERATION MODEL

(71) Applicant: Snap Inc., Santa Monica, CA (US)

(72) Inventors: Junli Cao, Los Angeles, CA (US); Anil Kag, Los Angeles, CA (US); Yanyu Li, Quincy, MA (US); Willi Menapace, Los Angeles, CA (US); Jian Ren, Marina Del Ray, CA (US); Aliaksandr Siarohin, Santa Monica, CA (US); Ivan Skorokhodov, Thuwal (SA); Sergey Tulyakov, Santa Monica, CA (US); Yushu Wu, Los Angeles, CA (US); Zhixing Zhang, Los Angeles, CA (US)

(21) Appl. No.: 18/829,898

(22) Filed: Sep. 10, 2024

(51) Int. Cl. G06T 11/00; G06V 10/774; G06V 10/776

(52) U.S. Cl. CPC G06T 11/00; G06V 10/774; G06V 10/776

(57) ABSTRACT

The present disclosure addresses technological challenges arising in the field of artificial intelligence (AI) with respect to inefficient use of computing resources and runtime delay. In particular, the present disclosure provides for development of a machine learning model that generates an image sample for a video in a single forward pass. The development of this machine learning model uses an adversarial training approach involving training two machine learning models, a generator model and a discriminator model. With the generator model trained in this way, the generator model can be used to generate image samples for a video in a single forward pass.

### TECHNICAL FIELD

Subject matter disclosed herein relates to techniques for automatic video generation. In particular, the subject matter disclosed herein relates to automatic video generation using machine learning techniques, including using a machine learning model to generate video with a single forward pass.

### BACKGROUND

In the field of artificial intelligence (AI), various machine learning models have been developed to perform various functions of varying complexity, such as classification, computer vision, and natural language processing. However, as machine learning models are tasked with performing more complex functions, these machine learning models face greater technological challenges with respect to, for example, costly and inefficient use of computational resources, inaccurate and insufficient data for training, and hardware limitations. For example, as machine learning models become more complex, these machine learning models require more computational resources and more processing time in order to perform their intended functions. As a result, these machine learning models cannot be run on normal computing systems and are unavailable for everyday use.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a machine learning pipeline, according to some examples.

FIG. 4 is a diagrammatic representation of training and use of a machine learning program, according to some examples.

FIG. 5 is a diagrammatic representation of a machine learning pipeline for training a machine learning model, according to some examples.

FIG. 6 is a diagrammatic representation of a temporal head and a spatial head of a machine learning model, according to some examples.

FIG. 7 is a diagrammatic representation of a method, according to some examples.

FIG. 8 is a diagrammatic representation of a data structure as maintained in a database, according to some examples.

FIG. 9 is a diagrammatic representation of a message, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

As machine learning models grow in complexity and sophistication, so too do the computational resources these machine learning models consume. For example, many machine learning models today use several iterations of processing to slowly approach a final result.

These machine learning models use a significant amount of computational resources because the amount of computational resources used for one iteration is multiplied several times in order to generate the final result. Furthermore, because these machine learning models use several iterations before generating a final result, these machine learning models may be unable to generate the result without a significant runtime delay. These technological challenges are particularly pronounced in technical areas such as video generation. For example, if a machine learning model requires several iterations of processing in order to generate one video frame, then whatever computational resources are used in one iteration of processing becomes multiplied exponentially in order to generate video frames for a video. Thus, machine learning models face technological challenges with respect to inefficient use of computing resources and runtime delay.

The present disclosure addresses these and other technological challenges arising in the field of artificial intelligence (AI). As an overview of some examples, the present disclosure provides for development of a machine learning model that generates an image sample for a video in a single forward pass. The development of this machine learning model uses an adversarial training approach. This adversarial training approach involves training two machine learning models, a generator model and a discriminator model. The generator model is trained to generate image samples based on an input (e.g., input image, input text). The discriminator model is trained to distinguish image samples generated by the generator model from image samples not generated by the machine learning model (e.g., captured images, manually created images). The discriminator model identifies image samples generated by the generator model based on spatial features and temporal features of the image samples. For example, the discriminator model can identify an image sample generated by the generator model based on spatial inconsistencies (e.g., inconsistent lighting, inconsistent details, contextual inconsistencies, misaligned objects, distorted objects, background-foreground discrepancies) and spatial errors (e.g., structural errors, unnatural patterns) in the image sample. The discriminator model can identify an image sample generated by the generator model based on temporal inconsistencies (e.g., inconsistent motion, unnatural positioning, inconsistent lighting changes) and temporal errors (e.g., motion jumps, freeze frames, unnatural changes) in the image sample relative to other image samples.

With the discriminator model trained to identify image samples generated by the generator model and image samples not generated by the generator model, the generator model is trained to generate image samples that the discriminator model identifies as not generated by the generator model. In order words, the generator model is trained to confuse the discriminator model or cause the discriminator model to incorrectly identify the image samples generated by the generator model. With the generator model trained in this way, the generator model can be used to generate image samples for a video in a single forward pass. For example, an input image is provided to the generator model. Based on the input image, the generator model generates a set of image samples for a video with a single forward pass, for example, by propagating the input image sequentially through the layers of the generator model. Thus, as illustrated in this example, the present disclosure provides for a machine learning model that efficiently generates image samples for a video with a single forward pass, which advantageously improves use of computational resources and reduces runtime delay. Further details related to the improvements described are provided below.

### Networked Computing Environment

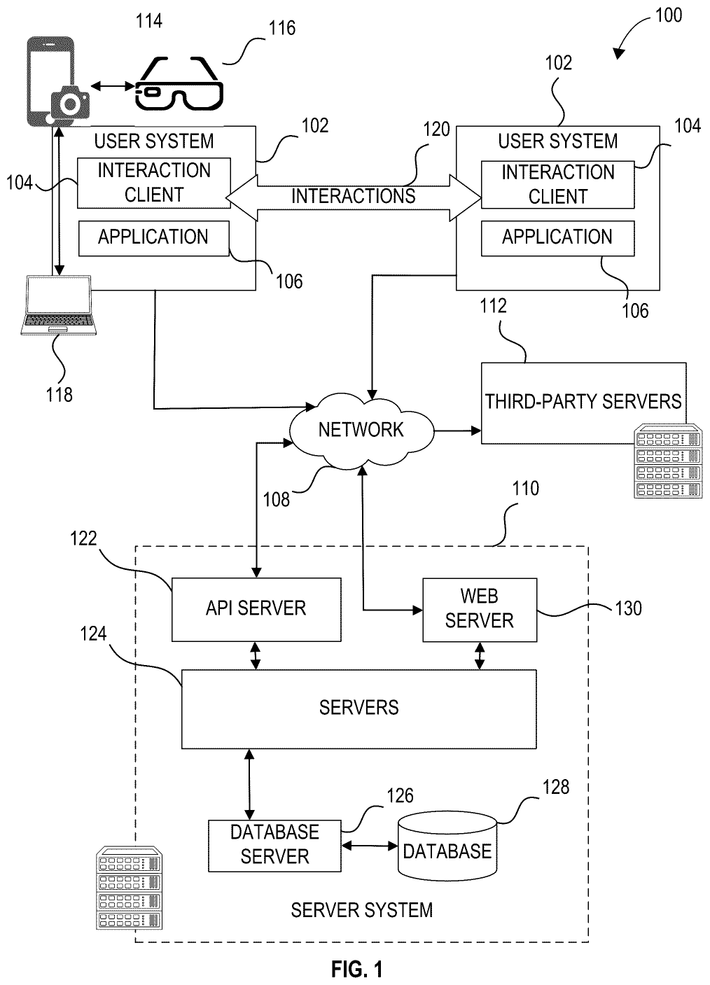

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 808); the location of friends within an entity relationship graph; and opening an application event (e.g., relating to the interaction client 104).

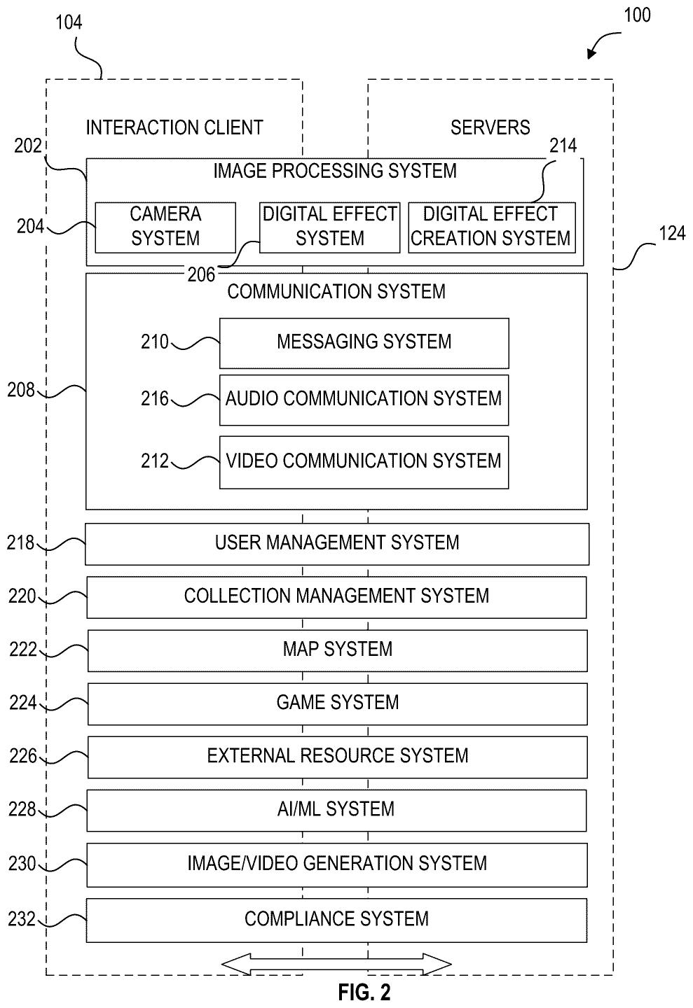

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application.

Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging.

The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 1302 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects.

Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 806, entity graphs 808 and profile data 802) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 802) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An artificial intelligence and machine learning system 228 provides a variety of services to different subsystems within the digital interaction system 100. For example, the artificial intelligence and machine learning system 228 operates with the image processing system 202 and the camera system 204 to analyze images and extract information such as objects, text, or faces. This information can then be used by the image processing system 202 to enhance, filter, or manipulate images. The artificial intelligence and machine learning system 228 is used by the digital effect system 206 to generate modified content and augmented reality experiences, such as adding virtual objects or animations to real-world images. The communication system 208 and messaging system 210 uses the artificial intelligence and machine learning system 228 to analyze communication patterns and provide insights into how users interact with each other and provide intelligent message classification and tagging, such as categorizing messages based on sentiment or topic. The artificial intelligence and machine learning system 228 provides chatbot functionality to message interactions 120 between user systems 102 and between a user system 102 and the server system 110. The artificial intelligence and machine learning system 228 also works with the audio communication system 216 to provide speech recognition and natural language processing capabilities, allowing users to interact with the digital interaction system 100 using voice commands.

The artificial intelligence and machine learning system 228 provides generative artificial intelligence functionality. An image generation system 230 may receive input from a user and pass the inputs to the artificial intelligence and machine learning system 228 to generate one or more images. In some instances, the artificial intelligence and machine learning system 228 generates a set of images for a video based on an input. The artificial intelligence and machine learning system 228 executes one or more machine learning models, such as one or more diffusion models, that generate images based on text prompts, input images, and/or other conditions. For example, the artificial intelligence and machine learning system 228 implements a text-to-image diffusion model or an image-to-video diffusion model.

The artificial intelligence and machine learning system 228 and the image generation system 230 may receive user input (e.g., prompt) originating from the interaction client 104 of a user system 102 of a user. The artificial intelligence and machine learning system 228 and the image generation system 230 causes generated outputs (e.g., images) to be transmitted and presented to the user via the interaction client 104.

The image and video generation system 230 works with various subsystems of the digital interaction system 100 to provide an enhanced experience on the interaction client 104 utilizing AI-generated images and AI-generated videos. For example, AI-generated images are used with the digital effect system 206 to provide digital effects based on AI-generated images. AI-generated videos are used with the digital effect system 206 to provide digital effects based on the AI-generated videos. For example, AI-generated videos are used with the digital effect creation system 214 to assist content creators with the creation and publication of digital effects using the AI-generated videos. For example, AI-generated videos are used with the game system 224 to provide the AI-generated videos within the context of a game.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws. In some examples, the compliance system 232 is responsible for content checking or content filtering, such as checking an input (e.g., prompt) provided to the image generation system 230 for objectionable language before allowing an output (e.g., image) to be generated based thereon. In some examples, the compliance system 232 checks a generated output (e.g., image) from the image generation system 230 for objectionable content before allowing the generated output to be transmitted and presented.

### Machine Learning Pipeline

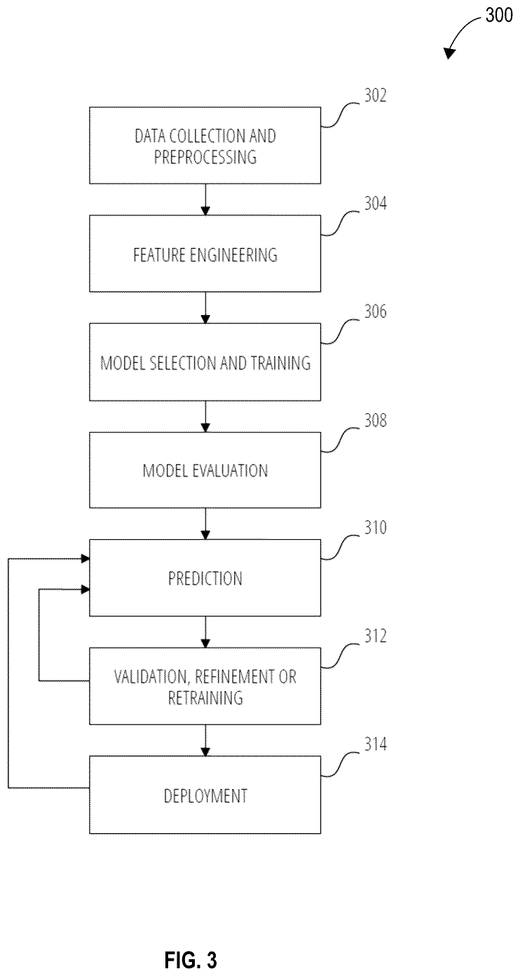

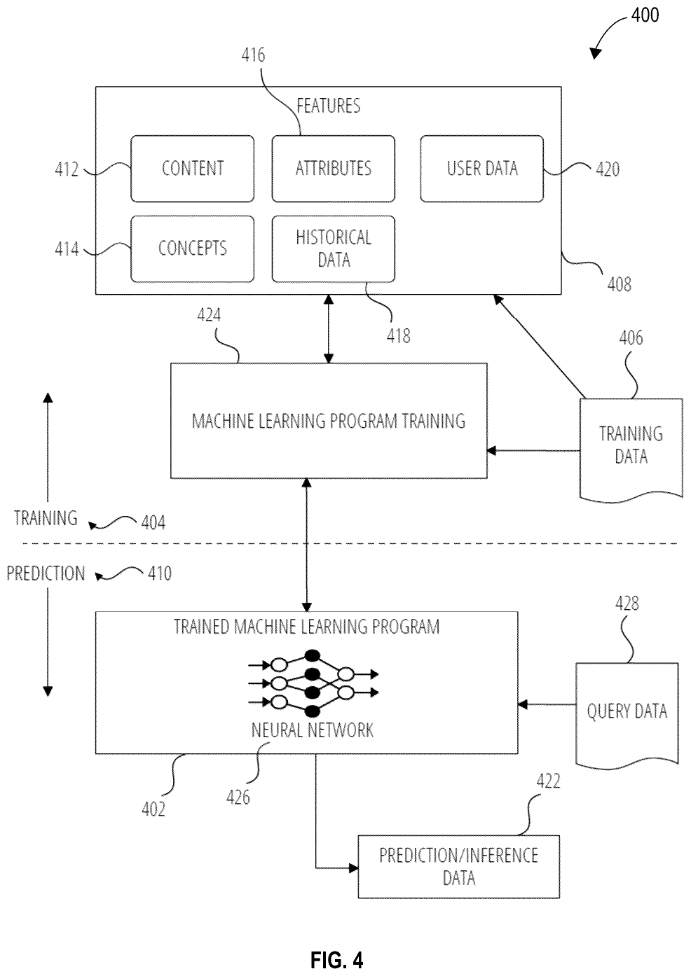

FIG. 3 is a flowchart 300 illustrating a machine learning pipeline, according to some examples. The machine learning pipeline may be used to generate a trained model such as, for example, the trained machine learning program 402 shown in the diagram 400 of FIG. 4.

Broadly, machine learning may involve using computer algorithms to automatically learn patterns and relationships in data, potentially without the need for explicit programming. Machine learning algorithms may be divided into three main categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and generative models, such as autoencoders.
Reinforcement learning involves training a model to make decisions in a dynamic environment by receiving feedback in the form of rewards or penalties. Examples of reinforcement learning algorithms may include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms may include decision trees, k-nearest neighbors, clustering algorithms, and deep learning algorithms, such as Convolutional Neural Networks (CNNs), Recurrent Neural Networks (RNNs), and transformer models. The choice of algorithm may depend on the nature of the data, the complexity of the problem, and the performance requirements of the application.

The performance of machine learning models may be evaluated on a separate test set of data that was not used during training to ensure that the model can generalize to new, unseen data. Although several specific examples of machine learning algorithms are discussed herein, the principles discussed herein can, where possible or relevant, be applied to other machine learning algorithms as well. Deep learning algorithms such as CNNs, RNNs, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning program 402 may include multiple phases that form part of the machine learning pipeline, including, for example, the following phases illustrated in FIG. 3:
Data collection and preprocessing 302: This phase may include acquiring and cleaning data to ensure that it is suitable for use in the machine learning model. This phase may also include removing duplicates, handling missing values, and converting data into a suitable format.
Feature engineering 304: This phase may include selecting and transforming the training data 406 to create features that are useful for predicting the target variable. Feature engineering may include (1) receiving features 408 (e.g., as structured or labeled data in supervised learning) and/or (2) identifying features 408 (e.g., unstructured, or unlabeled data for unsupervised learning) in training data 406.
Model selection and training 306: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 308: This phase may include evaluating the performance of a trained model (e.g., the trained machine learning program 402) on a separate testing dataset. This phase can help determine if the model is overfitting or underfitting and determine whether the model is suitable for deployment.
Prediction 310: This phase involves using a trained model (e.g., trained machine learning program 402) to generate predictions on new, unseen data.
Validation, refinement, or retraining 312: This phase may include updating a model based on feedback generated from the prediction phase, such as new data or user feedback.
Deployment 314: This phase may include integrating the trained model (e.g., the trained machine learning program 402) into a more extensive system or application, such as a web service, mobile app, or Internet of Things (IoT) device. This phase can involve setting up APIs, building a user interface, and ensuring that the model is scalable and can handle large volumes of data.

FIG. 4 is a block diagram 400 illustrating further details of two example phases, namely a training phase 404 (e.g., part of model selection and training 306) and a prediction phase 410 (part of prediction 310). Prior to the training phase 404, feature engineering 304 is used to identify features 408. This may include identifying informative, discriminating, and independent features for effectively operating the trained machine learning program 402 in pattern recognition, classification, and regression. In some examples, the training data 406 includes labeled data, known for pre-identified features 408 and one or more outcomes. Each of the features 408 may be a variable or attribute, such as an individual measurable property of a process, article, system, or phenomenon represented by a data set (e.g., the training data 406). Features 408 may also be of different types, such as numeric features, strings, and graphs, and may include one or more of content 412, concepts 414, attributes 416, historical data 418, and/or user data 420, merely for example.

In training phase 404, the machine learning program may use the training data 406 to find correlations among the features 408 that affect a predicted outcome or prediction/inference data 422. With the training data 406 and the identified features 408, the trained machine learning program 402 is trained during the training phase 404 during machine learning program training 424. The machine learning program training 424 appraises values of the features 408 as they correlate to the training data 406. The result of the training is the trained machine learning program 402 (e.g., a trained or learned model).

Further, the training phase 404 may involve machine learning, in which the training data 406 is structured (e.g., labeled during preprocessing operations). The trained machine learning program 402 may implement a neural network 426 capable of performing, for example, classification or clustering operations. In other examples, the training phase 404 may involve deep learning, in which the training data 406 is unstructured, and the trained machine learning program 402 implements a deep neural network 426 that can perform both feature extraction and classification/clustering operations.

In some examples, a neural network 426 may be generated during the training phase 404, and implemented within the trained machine learning program 402. The neural network 426 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 426 may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 426 may also be one of several different types of neural networks, such as a single-layer feed-forward network, a Multilayer Perceptron (MLP), an Artificial Neural Network (ANN), a RNN, a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 404, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction phase 410, the trained machine learning program 402 uses the features 408 for analyzing query data 428 to generate inferences, outcomes, or predictions, as examples of a prediction/inference data 422. For example, during prediction phase 410, the trained machine learning program 402 generates an output. Query data 428 is provided as an input to the trained machine learning program 402, and the trained machine learning program 402 generates the prediction/inference data 422 as output, responsive to receipt of the query data 428.

In some examples, the trained machine learning program 402 may be a generative AI model. Generative AI is a term that may refer to any type of AI that can create new content.

For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
VAEs: VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.
Diffusion models, as described below.

In generative AI examples, the prediction/inference data 422 may include predictions, translations, summaries, answers, media content, or combinations thereof.

A diffusion model is a type of generative machine learning model that can be used to generate images or videos from a given input (e.g., text prompt, input image). It is based on the concept of “diffusing” noise throughout an image to transform it gradually into a new image. A diffusion model may use a sequence of invertible transformations to transform a random noise image into a final image. During training, a diffusion model may learn sequences of transformations that can best transform random noise into desired output. A diffusion model can be fed with input data (e.g., a text describing the desired images and the corresponding output images, an input image and corresponding output videos), and the parameters of the model are adjusted iteratively to improve its ability to generate accurate or good quality images.

Once trained, in order to generate an image, the diffusion model applies a trained sequence of transformations to an input to generate an output image. The model generates the image in a step-by-step manner, updating the image sequentially with additional information until the image is fully generated. In some examples, this process may be repeated to produce a set of candidate images, from which the final image is chosen based on criteria such as a likelihood score. The resulting image may be intended to represent a visual interpretation of a text prompt. A diffusion model trained to generate a video applies a trained sequence of transformations to an input image to generate a set of output image samples. The model generates the image samples iteratively, updating the image samples with additional information in each iteration until the image samples are fully generated.

### Single Forward Pass Video Generation Models

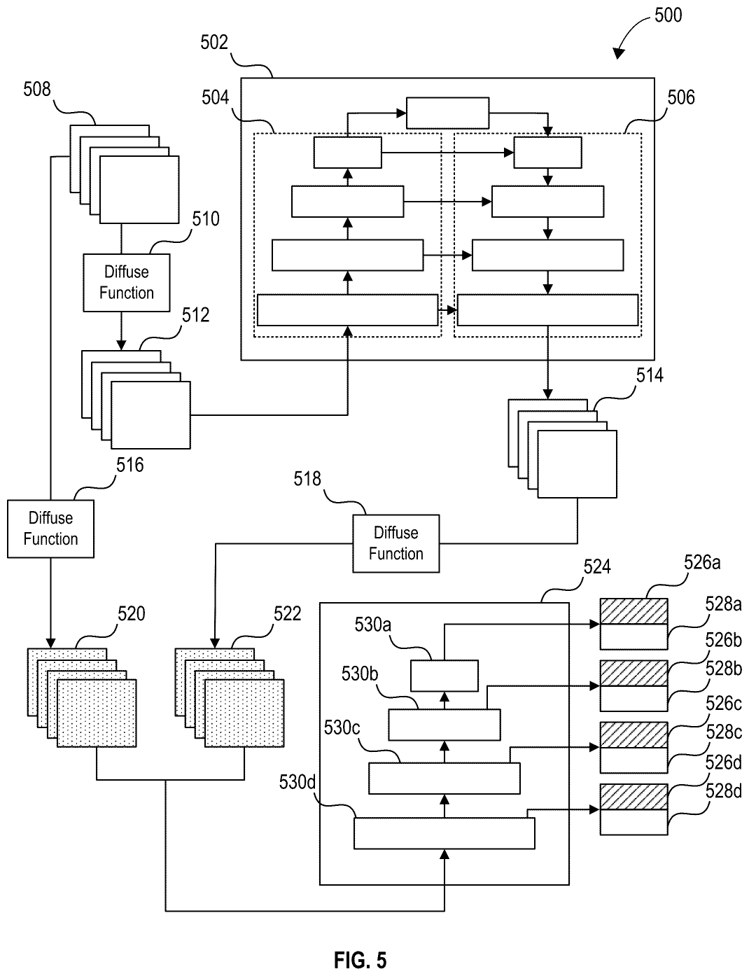

FIG. 5 is a block diagram 500 illustrating a machine learning pipeline for training a first machine learning model (e.g., generator model) and a second machine learning model (e.g., discriminator model) using adversarial training approaches, according to some examples. As illustrated in the block diagram 500, the machine learning pipeline includes a first machine learning model 502 and a second machine learning model 524. In some examples, the first machine learning model 502 is a generator model, such as a diffusion model or other video generation model, trained to generate image samples based on an input image. The second machine learning model 524 is a discriminator model, such as a binary classifier, trained to identify image samples as “fake” or “real. ” Fake image samples are image samples generated by a machine learning model, such as the generator model. Real image samples are image samples not generated by a machine learning model (e.g., captured images, manually created images).

As illustrated in FIG. 5, the first machine learning model 502 includes a first portion (e.g., encoder) 504 and a second portion (e.g., decoder) 506. The first portion 504 compresses input data into a latent representation in a latent space. The latent representation is passed to the second portion 506. The second portion 506 generates output data based on the latent representation. In some examples, the first machine learning model is initialized using weights of a trained machine learning model (e.g., trained generator model, trained diffusion model). The trained machine learning model can be trained, for example, based on the machine learning pipeline described in FIG. 3 and FIG. 4. In some examples, the first machine learning model is initialized and trained, for example, based on the machine learning pipeline described in FIG. 3 and FIG. 4. Either through training or through initializing using the weights of the trained machine learning model, the first machine learning model is capable of generating image samples based on an input image.

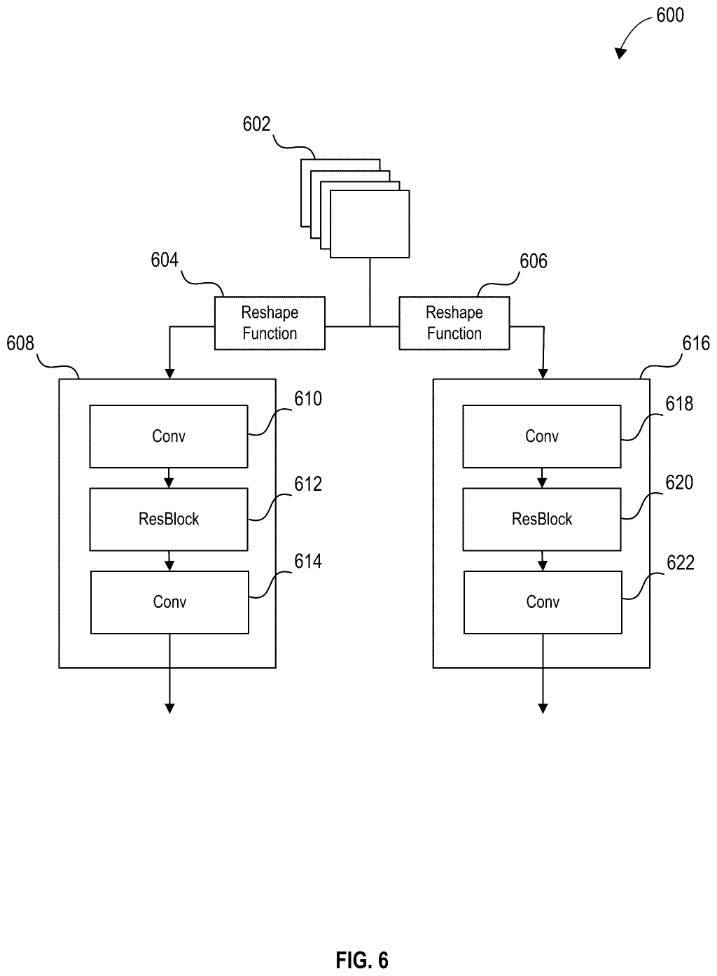

The second machine learning model 524 includes a backbone that, in some examples, is the same (e.g., same weights, same parameters) as the first portion (e.g., encoder) 504 of the first machine learning model 502. For each block of the backbone, the machine learning model 524 includes two spatial heads, a temporal head and a spatial head, that evaluate features generated by the block. For example, features generated by a first block 530a are evaluated by a first temporal head 526a and a first spatial head 528a. Features generated by a second block 530b are evaluated by a second temporal head 526b and a second spatial head 528b. Features generated by a third block 530c are evaluated by a third temporal head 526c and a third spatial head 528c. Features generated by a fourth block 530d are evaluated by a fourth temporal head 526d and a fourth spatial head 528d. The temporal heads 526a, 526b, 526c, 526d are trained to determine, based on temporal features generated by the blocks 530a, 530b, 530c, 530d, whether an image sample provided to the second machine learning model 524 is generated by a machine learning model or not generated by a machine learning model. The spatial heads 528a, 528b, 528c, 528d are trained to determine, based on spatial features generated by the blocks 530a, 530b, 530c, 530d, whether the image sample provided to the second machine learning model 524 is generated by a machine learning model or not generated by a machine learning model. Further details related to temporal heads and spatial heads are provided below with respect to FIG. 6.

In some examples, blocks 530d, 530c, 530b of the second machine learning model 524 each down-sample the spatial resolution of an input image sample by a factor of two and block 530a maintains the spatial resolution. While the example here illustrates a discriminator model with four blocks, four temporal heads, and four spatial heads, other configurations with different numbers of blocks, different numbers of temporal heads, different numbers of spatial heads, different numbers of blocks that down-sample spatial resolution, and different numbers of blocks that maintain spatial resolution are possible. In general, the number of temporal heads and the number of spatial heads correspond with the number of blocks in the backbone of the discriminator model. In some examples, a discriminator model with a greater number of blocks in the backbone would have a greater number of temporal heads and a greater number of spatial heads. A discriminator model with a smaller number of blocks in the backbone would have a smaller number of temporal heads and a smaller number of spatial heads.

The second machine learning model 524 is trained based on training data pairs including “real” image samples (e.g., image samples not generated by a machine learning model), such as real image samples 520, and “fake” image samples (e.g., image samples generated by a machine learning model), such as fake image samples 522. As illustrated in FIG. 5, the real image samples 520 are generated by applying a diffusion function 516 to a video dataset 508. The fake image samples 522 are generated by applying a diffusion function 518 to generated image samples 514. The generated image samples 514 are generated by the first machine learning model 502 based on a diffused video dataset 512. The diffused video dataset 512 can be generated by applying a diffusion function 510 to the video dataset 508.

In some examples, diffusion functions 510, 516, 518 are applied to add noise (e.g., Gaussian noise) to the video dataset 508 and the generated image samples 514. The diffusion functions 510, 516, 518 can be the same diffusion functions or different diffusion functions. For example, diffusion function 510 can be different from diffusion functions 516, 518 and diffusion functions 516, 518 can be the same diffusion function. In some examples, adjusting how much noise is added (e.g., noise levels) can alter the training of the first machine learning model 502 and the second machine learning model 524. For example, raising noise levels may make real image samples and fake image samples appear more similar. This can alter training of the first machine learning model 502 to emphasize generation of image samples with artifacts to increase the likelihood that the generated image samples 514 are identified as real image samples. Lowering noise levels may make real image samples easily distinguishable from fake image samples. This can alter training of the second machine learning model 524 to identify fake image samples and real image samples based on features that may not be meaningful or perceptible to people. As illustrated in these examples, the addition and adjustment of noise advantageously stabilizes training of the first machine learning model 502 and the second machine learning model 524 by providing balance to the real image samples and the fake image samples. Furthermore, by adjusting the noise distribution applied by the diffusion functions 510, 516, 518, training of the first machine learning model 502 and the second machine learning model 524 can be controlled to focus on different aspects.

The second machine learning model 524 is provided with real image samples 520 and fake image samples 522 and trained to identify the real image samples 520 as image samples not generated by a machine learning model and to identify the fake image samples 522 as image samples generated by a machine learning model. The second machine learning model 524 is trained to minimize a loss function that penalizes misclassifications (e.g., misidentifying a fake image sample, misidentifying a real image sample). In some examples, the second machine learning model is trained by modifying parameters of the temporal heads 526a, 526b, 526c, 526d and the spatial heads 528a, 528b, 528c, 528d while the backbone of the second machine learning model remains static. The parameters of the temporal heads 526a, 526b, 526c, 526d and the spatial heads 528a, 528b, 528c, 528d are modified, for example, through backpropagation to minimize the loss function. In some examples, the second machine learning model 524 is trained based on a hinge loss function that maximizes the margin between scores assigned to fake image samples and real image samples. For example, the hinge loss function can penalize the second machine learning model 524 for outputting scores below a first threshold (e.g., 1.0) for real image samples and for outputting scores above a second threshold (e.g., −1.0) for fake image samples.

The first machine learning model 502 is trained to generate image samples that are identified by the second machine learning model 524 as image samples not generated by a machine learning model. The first machine learning model 502 is trained, for example, to minimize a loss function that penalizes generation of image samples that are identified by the second machine learning model 524 as image samples generated by a machine learning model. The first machine learning model 502 is trained by modifying parameters of the first machine learning model 502 through backpropagation to minimize the loss function.

Following the adversarial training approaches illustrated in FIG. 5, the first machine learning model 502 and the second machine learning model 524 are trained in conjunction or in parallel. As the first machine learning model 502 is trained to generate image samples that are identified by the second machine learning model 524 as image samples not generated by a machine learning model, the second machine learning model 524 is also trained to identify image samples generated by the first machine learning model 502 as image samples generated by a machine learning model. In other words, the first machine learning model 502 and the second machine learning model 524 are trained with opposing objectives. The first machine learning model 502 is trained with an objective to minimize identifications by the second machine learning model 524 of image samples generated by the first machine learning model 502 as image samples generated by a machine learning model. The second machine learning model 524 is trained with an objective to minimize misidentifications of image samples generated by the first machine learning model 502 as image samples not generated by a machine learning model. Through these adversarial training approaches, the first machine learning model 502 is trained to generate high-quality image samples that can be confused for real image samples (e.g., captured image samples, manually created image samples).

A trained first machine learning model 502 generates image samples for a video based on an input image. For example, an input image can be provided to the trained first machine learning model 502. In some instances, the input image can be provided with additional conditions (e.g., text prompts), to guide the video generated by the first machine learning model 502. The trained first machine learning model 502 can generate a predetermined number of image samples for a video based on the input image. For example, the trained first machine learning model 502 can generate a video depicting an object in the input image performing an action described by a text prompt. The trained first machine learning model 502 can generate the image samples for a video using a single forward pass. An input image provided to the trained first machine learning model 502 is propagated through the layers of the trained first machine learning model 502 once and the image samples for the video are generated without further propagation through the layers of the trained first machine learning model 502. Thus, as illustrated in these examples, the training the first machine learning model using the adversarial training approaches described herein encourages the first machine learning model to generate image samples in a single forward pass rather than using a multi-pass process (e.g., multi-step denoising process) to generate the image samples. Thus, the present disclosure improves use of computational resources and reduces runtime delay by reducing the number of forward passes used to generate an output.

FIG. 6 is a block diagram 600 illustrating a spatial head 608 and a temporal head 616 of a discriminator model, such as the second machine learning model 524 of FIG. 5. In general, the spatial head 608 is trained to determine whether an image sample is generated by a machine learning model or not generated by a machine learning model based on spatial features of the image sample. The temporal head 616 is trained to determine whether an image sample is generated by a machine learning model or not generated by a machine learning model based on temporal features of the image sample.

As illustrated in FIG. 6, the spatial head 608 includes first convolutional layers 610, a residual block 612, and second convolutional layers 614. Inputs (e.g., image samples, features of image samples) 602 are passed through a reshape function 604 and provided to the spatial head 608. The reshape function 604 reshapes the inputs 602 to predetermined, uniform dimensions. For example, an input of shape b x t x c x h x w is reshaped to (bt) x c x h x w for the spatial head 608, where b is a batch size, t is a number of image samples in a video, c is a number of channels in an image sample, h is a height of the image sample, and w is a weight of the image sample. By merging the batch and temporal (e.g., number of image samples in a video) dimensions of the input 602, each image sample is analyzed by the spatial head 608 as an independent image sample. As the inputs 602 are passed through the first convolutional layers 610, the residual block 612, and the second convolutional layers 614, spatial features are extracted from each image sample of the inputs 602 and analyzed for spatial patterns, spatial structures, and other spatial qualities that are indicative of the image sample being generated by a machine learning model or not being generated by a machine learning model.

The temporal head 616 includes first convolutional layers 618, a residual block 612, and second convolutional layers 622. The inputs 602 are passed through a reshape function 606 and provided to the temporal head 616. The reshape function 606 reshapes the inputs 602 to predetermined, uniform dimensions. For example, an input of shape b x t x c x h x w is reshaped to (bhw) x c x t for the temporal head 616, where b is a batch size, t is a number of image samples in a video, c is a number of channels in an image sample, h is a height of the image sample, and w is a weight of the image sample. By merging the batch, height, and width dimensions of the input 602, the inputs 602 are analyzed by the temporal head 616 with an emphasis on temporal correlations between the image samples. As the inputs 602 are passed through the first convolutional layers 618, the residual block 620, and the second convolutional layers 622, temporal features are extracted from each image sample of the inputs 602 and analyzed for temporal patterns and other temporal qualities that are indicative of the image sample being generated by a machine learning model or not being generated by a machine learning model.

In some examples, the inputs 602 provided to the spatial head 608 and the temporal head 616 include information such as frame index and other image conditions. For example, providing the frame index to the temporal head 616 provides for improved analysis of the inputs 602 because the temporal head 616 can determine the temporal relationship between the image samples of the inputs 602.

In some examples, the spatial head 608 and the temporal head 616 operate in parallel on the inputs 602. By using both spatial heads and temporal heads, a discriminator model advantageously evaluates image samples for a video with respect to both spatial properties and temporal properties. For example, a discriminator model without temporal heads would only evaluate image samples for a video with respect to spatial properties and may encourage a generator model to output image samples depicting minimal movement. On the other hand, a discriminator model without spatial heads would only evaluate image samples for a video with respect to temporal properties and may encourage a generator model to output image samples depicting inconsistent objects and patterns.

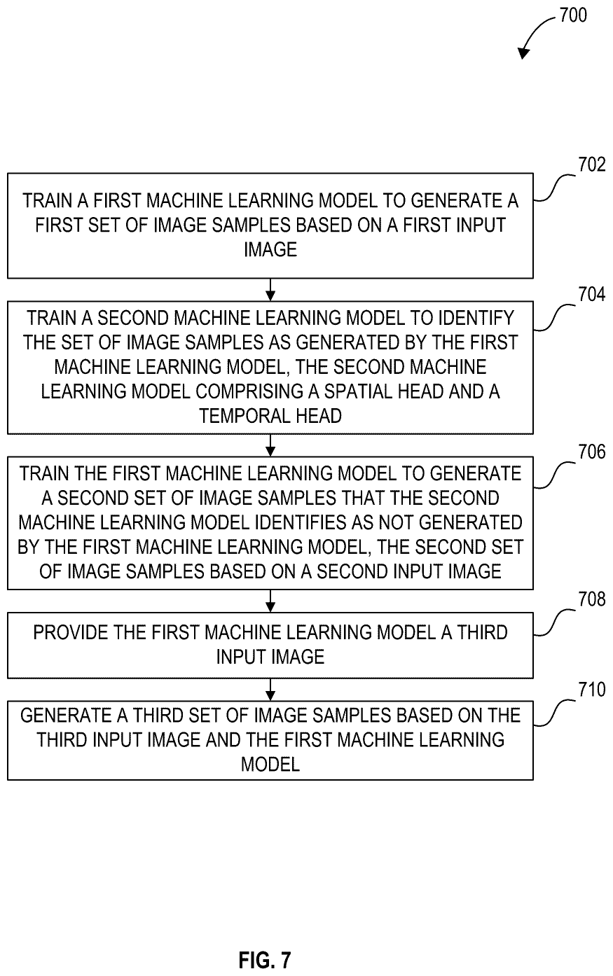

FIG. 7 illustrates an example method 700, according to some examples. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

At operation 702, the example method 700 trains a first machine learning model to generate a first set of image samples based on a first input image. The first machine learning model can be trained, for example, based on the machine learning pipeline described with respect to FIG. 5. At operation 704, the example method 700 trains a second machine learning model to identify the set of image samples as generated by the first machine learning model, the second machine learning model comprising a spatial head and a temporal head. The second machine learning model can be trained, for example, based on the machine learning pipeline described with respect to FIG. 5. The spatial head and the temporal head of the second machine learning model can include features described with respect to FIG. 6. At operation 706, the example method 700 trains the first machine learning model to generate a second set of image samples that the second machine learning model identifies as not generated by the first machine learning model, the second set of image samples based on a second input image. The first machine learning model can be trained, for example, based on the machine learning pipeline described with respect to FIG. 5. At operation 708, the example method 700 provides the first machine learning model a third input image. At operation 710, the example method 700 generates a third set of image samples based on the third input image and the first machine learning model.

### Data Architecture

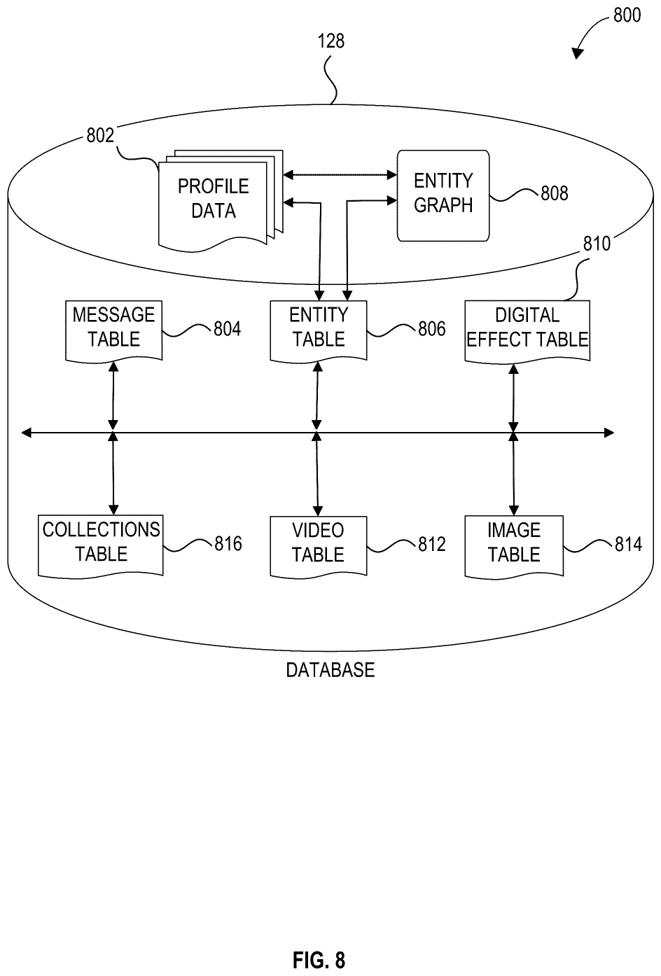

FIG. 8 is a schematic diagram illustrating data structures 800, which may be stored in the database 128 of the server system 110, according to certain examples. While the content of the database 128 is shown to comprise multiple tables, it will be appreciated that the data could be stored in other types of data structures (e.g., as an object-oriented database).

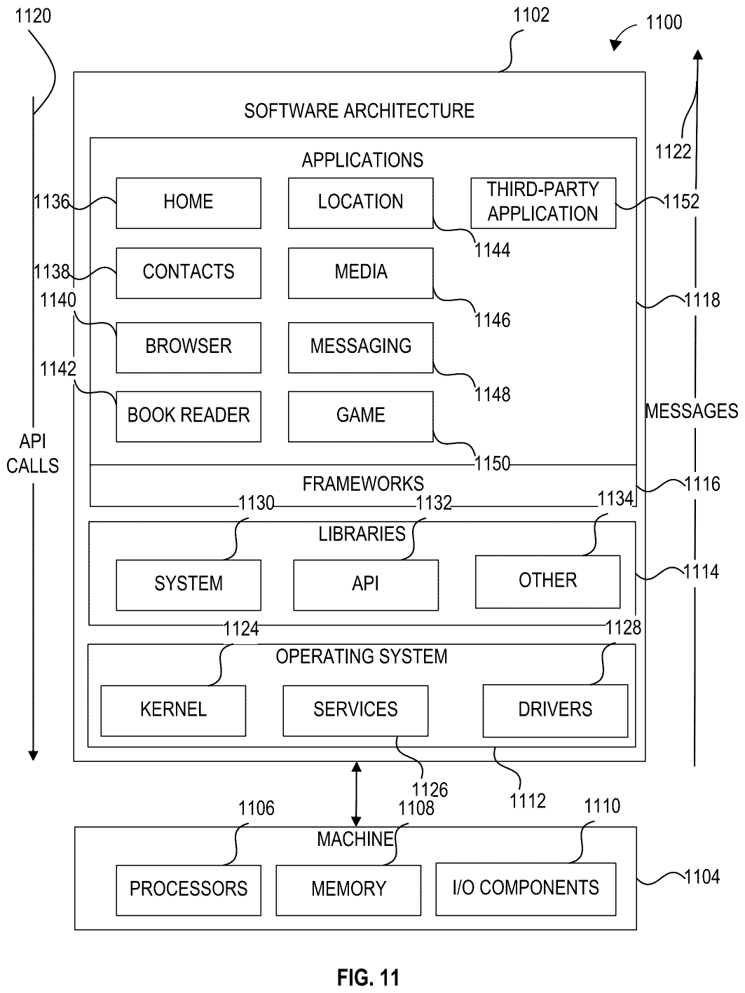

The database 128 includes message data stored within a message table 804. This message data includes at least message sender data, message recipient (or receiver) data, and a payload. Further details regarding information that may be included in a message, and included within the message data stored in the message table 804, are described below with reference to FIG. 11.

An entity table 806 stores entity data, and is linked (e.g., referentially) to an entity graph 808 and profile data 802. Entities for which records are maintained within the entity table 806 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 808 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 806. Such privacy settings may be applied to all types of relationships within the context of the digital interaction system 100, or may selectively be applied to certain types of relationships.

The profile data 802 stores multiple types of profile data about a particular entity. The profile data 802 may be selectively used and presented to other users of the digital interaction system 100 based on privacy settings specified by a particular entity. Where the entity is an individual, the profile data 802 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 802 for the group may similarly include one or more avatar representations associated with the group, in addition to the group name, members, and various settings (e.g., notifications) for the relevant group.

The database 128 also stores digital effect data, such as overlays or filters, in a digital effect table 810. The digital effect data is associated with and applied to videos (for which data is stored in a video table 812) and images (for which data is stored in an image table 814).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 814 includes augmented reality content items (e.g., corresponding to augmented reality experiences). An augmented reality content item may be a real-time special effect and sound that may be added to an image or a video.

A collections table 816 stores data regarding collections of messages and associated image, video, or audio data, which are compiled into a collection (e.g., a narrative or a gallery). The creation of a particular collection may be initiated by a particular user (e.g., each user for which a record is maintained in the entity table 806). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 812 stores video data that, in some examples, is associated with messages for which records are maintained within the message table 804.

Similarly, the image table 814 stores image data associated with messages for which message data is stored in the entity table 806. The entity table 806 may associate various digital effects from the digital effect table 810 with various images and videos stored in the image table 814 and the video table 812.

### Data Communications Architecture

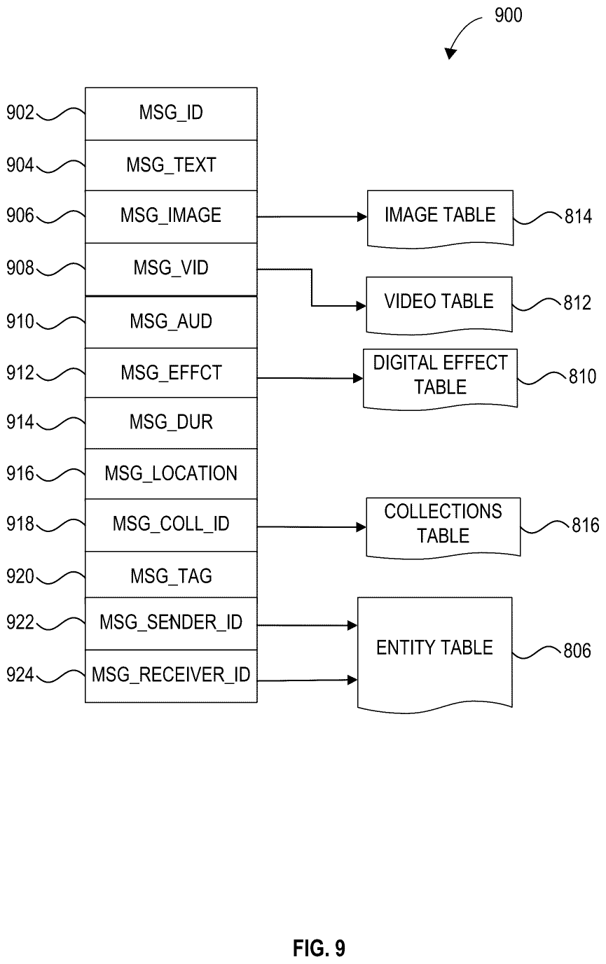

FIG. 9 is a schematic diagram illustrating a structure of a message 900, according to some examples, generated by an interaction client 104 for communication to a further interaction client 104 via the servers 124. The content of a particular message 900 is used to populate the message table 804 stored within the database 128, accessible by the servers 124. Similarly, the content of a message 900 is stored in memory as “in-transit” or “in-flight” data of the user system 102 or the servers 124. A message 900 is shown to include the following example components:
Message identifier 902: a unique identifier that identifies the message 900.
Message text payload 904: text, to be generated by a user via a user interface of the user system 102, and that is included in the message 900.
Message image payload 906: image data, captured by a camera component of a user system 102 or retrieved from a memory component of a user system 102, and that is included in the message 900. Image data for a sent or received message 900 may be stored in the image table 814.
Message video payload 908: video data, captured by a camera component or retrieved from a memory component of the user system 102, and that is included in the message 900. Video data for a sent or received message 900 may be stored in the video table 812.
Message audio payload 910: audio data, captured by a microphone or retrieved from a memory component of the user system 102, and that is included in the message 900.
Message digital effect data 912: digital effect data (e.g., filters, stickers, or other annotations or enhancements) that represents digital effects to be applied to message image payload 906, message video payload 908, or message audio payload 910 of the message 900. Digital effect data for a sent or received message 900 may be stored in the digital effect table 810.
Message duration parameter 914: parameter value indicating, in seconds, the amount of time for which content of the message (e.g., the message image payload 906, message video payload 908, message audio payload 910) is to be presented or made accessible to a user via the interaction client 104.
Message geolocation parameter 916: geolocation data (e.g., latitudinal, and longitudinal coordinates) associated with the content payload of the message. Multiple message geolocation parameter 916 values may be included in the payload, each of these parameter values being associated with respect to content items included in the content (e.g., a specific image within the message image payload 906, or a specific video in the message video payload 908).
Message collection identifier 918: identifier values identifying one or more content collections (e.g., “stories” identified in the collections table 816) with which a particular content item in the message image payload 906 of the message 900 is associated. For example, multiple images within the message image payload 906 may each be associated with multiple content collections using identifier values.
Message tag 920: each message 900 may be tagged with multiple tags, each of which is indicative of the subject matter of content included in the message payload. For example, where a particular image included in the message image payload 906 depicts an animal (e.g., a lion), a tag value may be included within the message tag 920 that is indicative of the relevant animal. Tag values may be generated manually, based on user input, or may be automatically generated using, for example, image recognition.
Message sender identifier 922: an identifier (e.g., a messaging system identifier, email address, or device identifier) indicative of a user of the user system 102 on which the message 900 was generated and from which the message 900 was sent.
Message receiver identifier 924: an identifier (e.g., a messaging system identifier, email address, or device identifier) indicative of a user of the user system 102 to which the message 900 is addressed.

The contents (e.g., values) of the various components of message 900 may be pointers to locations in tables within which content data values are stored. For example, an image value in the message image payload 906 may be a pointer to (or address of) a location within an image table 814. Similarly, values within the message video payload 908 may point to data stored within a video table 314, values stored within the message digital effect data 912 may point to data stored in a digital effect table 810, values stored within the message collection identifier 918 may point to data stored in a collections table 816, and values stored within the message sender identifier 922 and the message receiver identifier 924 may point to user records stored within an entity table 806.

### Machine Architecture

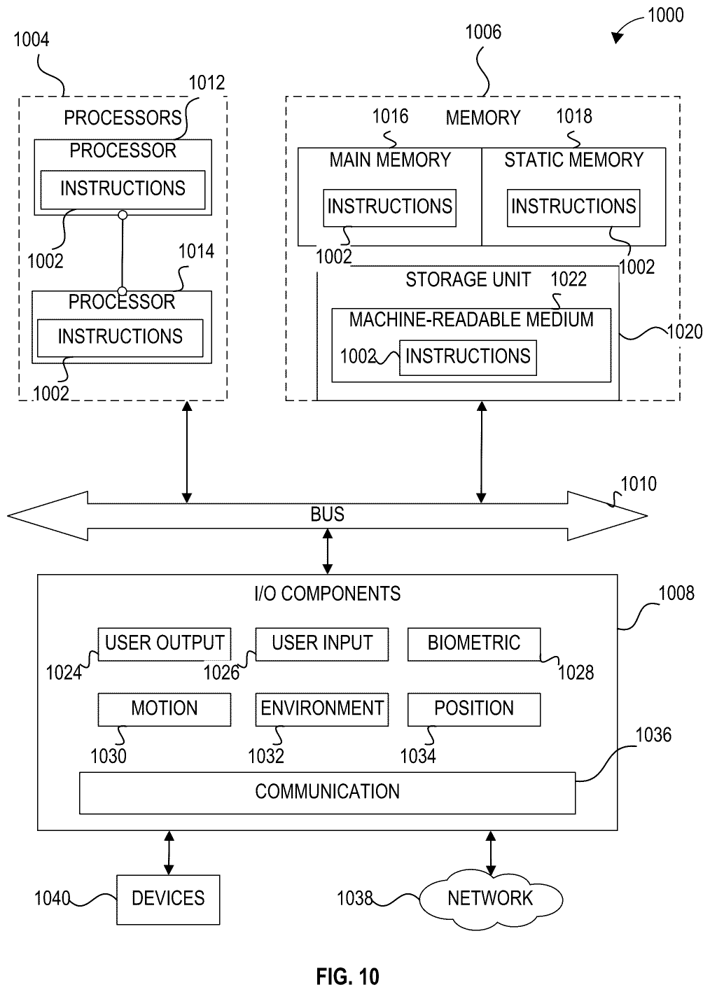

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include processors 1004, memory 1006, and input/output I/O components 1008, which may be configured to communicate with each other via a bus 1010.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 1030 include acceleration sensor components (e.g., accelerometer), gravitation sensor components, rotation sensor components (e.g., gyroscope).

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality.

The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C. ” Unless explicitly stated otherwise in connection with a particular instance in this disclosure, this manner of phrasing does not mean “at least one of A, at least one of B, and at least one of C. ” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to. ”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number, respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1 is a system comprising: at least one processor; and at least one memory component storing instructions that, when executed by the at least one processor, cause the at least one processor to perform operations comprising: training a first machine learning model to generate a first set of image samples based on a first input image; training a second machine learning model to identify the set of image samples as generated by the first machine learning model, the second machine learning model comprising a spatial head and a temporal head; training the first machine learning model to generate a second set of image samples that the second machine learning model identifies as not generated by the first machine learning model, the second set of image samples based on a second input image; providing the first machine learning model a third input image; and generating a third set of image samples based on the third input image and the first machine learning model.

In Example 2, the subject matter of Example 1 includes initializing the first machine learning model based on weights of a trained machine learning model.

In Example 3, the subject matter of Examples 1-2 includes the first machine learning model comprises a first portion and a second portion, the second machine learning model comprises a third portion with weights and parameters of the first portion.

In Example 4, the subject matter of Examples 1-3 includes the spatial head and the temporal head correspond with a block of a backbone of the second machine learning model, the spatial head evaluates spatial features generated by the block, and the temporal head evaluates temporal features generated by the block.

In Example 5, the subject matter of Examples 1-4 includes the spatial head is trained to identify spatial errors in an image sample, the temporal head is trained to identify temporal errors in the image sample.

In Example 6, the subject matter of Examples 1-5 includes providing training data pairs, the training data pairs comprising image samples and generated image samples corresponding to the image samples, the generated image samples generated by the first machine learning model.

In Example 7, the subject matter of Examples 1-6 includes modifying first parameters of the spatial head and second parameters of the temporal head based on a hinge loss function.

In Example 8, the subject matter of Examples 1-7 includes reshaping an input to the spatial head to merge batch dimensions and temporal dimensions of the input.

In Example 9, the subject matter of Examples 1-8 includes reshaping an input to the temporal head to merge batch dimensions, height dimensions, and width dimensions of the input.

In Example 10, the subject matter of Examples 1-9 includes a backbone of the second machine learning model is unmodified while training the second machine learning model.

In Example 11, the subject matter of Examples 1-10 includes applying noise to the first set of image samples and the second set of image samples.

In Example 12, the subject matter of Examples 1 -11 includes modifying parameters of the first machine learning model to minimize a loss function that penalizes generation of image samples identified by the second machine learning model as image samples generated by the first machine learning model.

In Example 13, the subject matter of Example 1-12 includes the third input image is provided with a text prompt, the third set of image samples being generated based on the third input image and the text prompt.

In Example 14, the subject matter of Example 1-13 includes the first machine learning model generates the third set of image samples with a single forward pass.

Example 15 is a method to implement Examples 1-14.

Example 16 is a non-transitory computer-readable storage medium to implement Examples 1-14.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, network attached storage (NAS), storage area networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled, or owned by a user and with which the user interacts perform an action, engagement, or interaction on the user device, including an interaction with other users or computer systems.

What is claimed is:

1. A system comprising:
at least one processor; and
at least one memory component storing instructions that, when executed by the at least one processor, cause the at least one processor to perform operations comprising:
training a first machine learning model to generate a first set of image samples based on a first input image;
training a second machine learning model to identify the first set of image samples as generated by the first machine learning model, the second machine learning model comprising a spatial head and a temporal head;
training the first machine learning model to generate a second set of image samples that the second machine learning model identifies as not generated by the first machine learning model, the second set of image samples based on a second input image;
providing the first machine learning model a third input image; and
generating a third set of image samples based on the third input image and the first machine learning model.

2. The system of claim 1, wherein training the first machine learning model to generate the first set of image samples comprises:
initializing the first machine learning model based on weights of a trained machine learning model.

3. The system of claim 1, wherein the first machine learning model comprises a first portion and a second portion, the second machine learning model comprises a third portion with weights and parameters of the first portion.

4. The system of claim 1, wherein the spatial head and the temporal head correspond with a block of a backbone of the second machine learning model, the spatial head evaluates spatial features generated by the block, and the temporal head evaluates temporal features generated by the block.

5. The system of claim 1, wherein the spatial head is trained to identify spatial errors in an image sample, the temporal head is trained to identify temporal errors in the image sample.

6. The system of claim 1, wherein training the second machine learning model to identify the first set of image samples as generated by the first machine learning model comprises:
providing training data pairs, the training data pairs comprising image samples and generated image samples corresponding to the image samples, the generated image samples generated by the first machine learning model.

7. The system of claim 1, wherein training the second machine learning model to identify the first set of image samples as generated by the first machine learning model comprises:
modifying first parameters of the spatial head and second parameters of the temporal head based on a hinge loss function.

8. The system of claim 1, wherein training the second machine learning model to identify the first set of image samples as generated by the first machine learning model comprises:
reshaping an input to the spatial head to merge batch dimensions and temporal dimensions of the input.

9. The system of claim 1, wherein training the second machine learning model to identify the first set of image samples as generated by the first machine learning model comprises:
reshaping an input to the temporal head to merge batch dimensions, height dimensions, and width dimensions of the input.

10. The system of claim 1, wherein a backbone of the second machine learning model is unmodified while training the second machine learning model.

11. The system of claim 1, the operations further comprising:
applying noise to the first set of image samples and the second set of image samples.

12. The system of claim 1, wherein training the first machine learning model to generate the second set of image samples comprises:
modifying parameters of the first machine learning model to minimize a loss function that penalizes generation of image samples identified by the second machine learning model as image samples generated by the first machine learning model.

13. The system of claim 1, wherein the third input image is provided with a text prompt, the third set of image samples being generated based on the third input image and the text prompt.

14. The system of claim 1, wherein the first machine learning model generates the third set of image samples with a single forward pass.

15. A computer-implemented method comprising:
training a first machine learning model to generate a first set of image samples based on a first input image;
training a second machine learning model to identify the first set of image samples as generated by the first machine learning model, the second machine learning model comprising a spatial head and a temporal head;
training the first machine learning model to generate a second set of image samples that the second machine learning model identifies as not generated by the first machine learning model, the second set of image samples based on a second input image;
providing the first machine learning model a third input image; and
generating a third set of image samples based on the third input image and the first machine learning model.

16. The computer-implemented method of claim 15, wherein training the first machine learning model to generate the first set of image samples comprises:
initializing the first machine learning model based on weights of a trained machine learning model.

17. The computer-implemented method of claim 15, wherein the first machine learning model comprises a first portion and a second portion, the second machine learning model comprises a third portion with weights and parameters of the first portion.

18. The computer-implemented method of claim 15, wherein the spatial head and the temporal head correspond with a block of a backbone of the second machine learning model, the spatial head evaluates spatial features generated by the block, and the temporal head evaluates temporal features generated by the block.

19. A non-transitory computer-readable storage medium storing instructions that, when executed by at least one processor, cause the at least one processor to perform operations comprising:
training a first machine learning model to generate a first set of image samples based on a first input image;
training a second machine learning model to identify the first set of image samples as generated by the first machine learning model, the second machine learning model comprising a spatial head and a temporal head;
training the first machine learning model to generate a second set of image samples that the second machine learning model identifies as not generated by the first machine learning model, the second set of image samples based on a second input image;
providing the first machine learning model a third input image; and
generating a third set of image samples based on the third input image and the first machine learning model.

20. The non-transitory computer-readable storage medium of claim 19, wherein training the first machine learning model to generate the first set of image samples comprises:
initializing the first machine learning model based on weights of a trained machine learning model.
